(19) United States
(12) Patent Application Publication
(10) Pub. No.: US 2012/0068004 A1
(43) Pub. Date: Mar. 22, 2012

(54) Auto-hover and auto-pilot helicopter

(76) Inventor: Mehdi Hatamian, Dove Canyon, CA (US)

(21) Appl. No.: 12/930,865

(22) Filed: Jan. 19, 2011

Related U.S. Application Data
(60) Provisional application No. 61/336,259, filed on Jan. 19, 2010.

(51) Int. Cl. B64C 27/57

(52) U.S. Cl. 244/17.13

(57) ABSTRACT

A helicopter gyroscope mounted on the moving swash plate rather than in or on the body of the helicopter will improve the helicopters hovering capability and auto-pilot performance.

### CROSS-REFERENCE TO RELATED APPLICATIONS

This application is entitled to the benefit of Provisional Application Ser. No. 61/336,259 filed Jan. 19, 2010.

### BACKGROUND

The present invention describes a device for assisting in the automatic hovering of a helicopter as well as flying it in an auto-pilot mode. The device can be used both on radio controlled helicopters as well as life-size machines and operates based on the same principle in both cases.

Prior art uses motion and position sensors mounted in or on the body of the helicopter to stabilize the position of the aircraft in reference to the ground.

### SUMMARY

In accordance with one embodiment of the invented system a helicopter having a rotor assembly and a swash plate uses a position sensing device mounted on the helicopter's swash plate. The the position sensing device transmits a signal to a swash plate attitude controller; and the swash plate attitude controller adjusts the angle of the swash plate. This enables the swash plate to conform to a predetermined swash plate angle wherein the predetermined swash plate angle is such that a stable hover is maintained over a particular location.

### BRIEF DESCRIPTION OF THE DRAWINGS

FIG. 1 shows how a swash plate controls the pitch of the main rotor blades

FIG. 2 illustrates how the swash plate reacts to the gyroscope signal

### DESCRIPTION

Perfect Hover:

To keep a helicopter in perfect hover at a certain height, there must be no movements or roll along or in the direction of any of the X, Y or Z axis of the 3D space. The rotation about the vertical Z axis, the yaw, is usually controlled via the pitch of the tail blade (except for twin rotor helicopters). There are well-known techniques for automatically controlling the rotation of the helicopter about the vertical axis using a gyroscope that senses rotation along the Z-axis. However, the control of the movements of the helicopter about the X and Y axes is not as simple and straightforward, mainly due to the fact that sensing the movements about the X and Y axes, with any gyroscope-based device that is installed anywhere inside the body or on the body of helicopter, will not result in the proper feedback signals for bringing the machine into a hover. This is due to the fact that, in general, when a helicopter is in perfect hover, the body of the machine is not necessarily in a perfect level position.

Hovering is the most challenging part of flying a helicopter. This is because a helicopter generates its own gusty air while in a hover, which acts against the fuselage and flight control surfaces. The end result is constant control inputs and corrections by the pilot to keep the helicopter where it is required to be. Despite the complexity of the task, the control inputs in a hover are simple. The cyclic is used to eliminate drift in the horizontal plane, which is to control forward and back, right and left. The collective is used to maintain altitude. The pedals are used to control nose direction or heading. It is the interaction of these controls that makes hovering so difficult, since an adjustment in any one control requires an adjustment of the other two, creating a cycle of constant correction.

Swash Plate:

The swash plate is a metal component with a typically flat surface that sits on the main shaft of a helicopter and can freely rotate around the X and Y axes of the machine. The tilt of the rotating swash plate (leaving the X-Y plane) is controlled via linkages to servo mechanisms installed on the body of the helicopter. It is the rotation angle and tilt of this swash plate that determines the direction of the movement of the helicopter. The position and angle of the swash plate therefor act as the helicopter's aileron and elevator. The aileron control changes the angle of the swash plate about the X axis resulting in left and right movements. The elevator control changes the angle of the swash plate about the Y axis resulting in forward and backward movement. The combination of these controls along with the tail pitch control and the throttle (which also controls the pitch of the main blades of the helicopter) determine the flight dynamics of the helicopter and control its movements and speed.

A helicopter has four flight control inputs. These are the cyclic, the collective, the anti-torque pedals, and the throttle. The cyclic control is usually located between the pilot's legs and is commonly called the cyclic stick or just cyclic. On most helicopters, the cyclic is similar to a joystick.

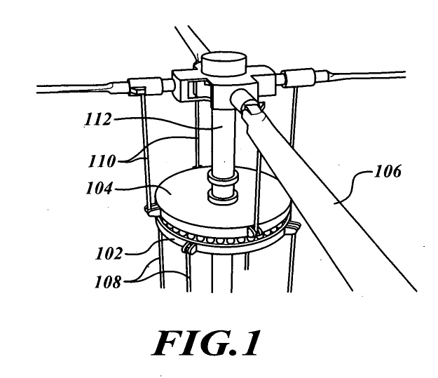

The control is called the cyclic because it changes the pitch of the rotor blades cyclically. The result is to tilt the fixed swash plate; FIG. 1 102, in a particular direction, resulting in the helicopter moving in that direction. If the pilot pushes the cyclic forward, the swash plate 102 tilts forward, which produces a thrust in the forward direction. If the pilot pushes the cyclic to the side, the swash plate 102 disk tilts to that side and produces thrust in that direction, causing the helicopter to move sideways.

The collective pitch control or collective is located on the left side of the pilot's seat with a settable friction control to prevent inadvertent movement. The collective changes the pitch angle of all the main rotor blades collectively (i.e. all at the same time) and independently of their position. Therefore, if a collective input is made, all the blades change equally, and the result is the helicopter increasing or decreasing in altitude.

The anti-torque pedals are located in the same position as the rudder pedals in a fixed-wing aircraft, and serve a similar purpose, namely to control the direction in which the nose of the aircraft is pointed. Application of the pedal in a given direction changes the pitch of the tail rotor blades, increasing or reducing the thrust produced by the tail rotor and causing the nose to yaw in the direction of the applied pedal. The pedals mechanically change the pitch of the tail rotor altering the amount of thrust produced.

Helicopter rotors are designed to operate at a specific RPM. The throttle controls the power produced by the engine, which is connected to the rotor by a transmission. The purpose of the throttle is to maintain enough engine power to keep the rotor RPM within allowable limits in order to keep the rotor producing enough lift for flight. In single-engine helicopters, the throttle control is a motorcycle-style twist grip mounted on the collective control, while dual-engine helicopters have a power lever for each engine.

The swash plate FIG. 1 consists of two main parts: a stationary (fixed) swash plate 102 and a rotating swash plate 104. The stationary lower swash plate surrounds the rotating drive shaft but is fixed to the helicopter chassis and is connected to the cyclic and collective controls by a series of pushrods 108. It is able to tilt in all directions and move vertically. The pitch control rods 110 are what changes the pitch of the main rotor blades 106. The rotating upper swash plate 104 is mounted to the stationary swash plate 102 by means of bearings and is allowed to rotate with the drive shaft 112. An anti-rotation link prevents the upper swash plate from rotating independently of the blades 106, which would apply torque to the actuators. Both swash plates tilt up and down as one unit.

There are many different types of linkages used to change the pitch of the rotor blades and the example above is just one of those many types.

In forward flight a helicopter's flight controls behave more like that in a fixed-wing aircraft. Displacing the cyclic forward will cause the nose to pitch down, with a resultant increase in airspeed and loss of altitude. Aft cyclic will cause the nose to pitch up, slowing the helicopter and causing it to climb. Increasing collective (power) while maintaining a constant airspeed will induce a climb while decreasing collective will cause a descent. Coordinating these two inputs, down collective plus aft cyclic or up collective plus forward cyclic, will result in airspeed changes while maintaining a constant altitude. The pedals serve the same function in both a helicopter and a fixed-wing aircraft, to maintain balanced flight.

Smart Swash Plate:

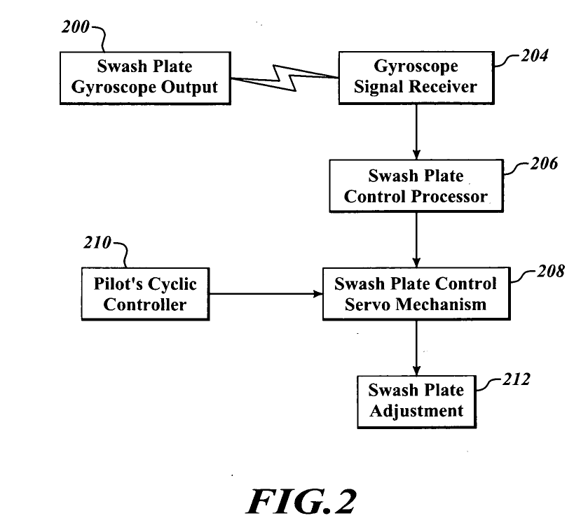

The main observation behind the creation of the present unique auto-hover device is the fact that if the swash plate of a helicopter is in a perfect leveled position it will not have any pitch or roll movements about the X and Y axes. The device can essentially be defined as a smart swash plate, with an embedded two-axis gyroscope with fast response time that is built into the plate itself. See FIG. 2. The device can either be attached to the moving swash plate or embedded within the moving swash plate. The output of the gyroscope 200 is wirelessly transmitted to a receiver 204 followed by a control processor 206 inside the helicopter's cabin. The received signals, which are an indication of the angle of the swash plate, are used by the processor to control the servo mechanisms 208 that control the position of the swash plate 212 and balance it to a perfect hovering level. The servo mechanisms also accept inputs from the pilot's controls 210. This control, along with conventional schemes to control the rotation of the helicopter along the vertical axis, known as the yaw, result in a complete auto-hover device. Once a perfect hover is achieved, a conventional GPS device installed in the helicopter along with an altimeter both linked to the above processor can be used to automatically achieve any desired flight path until the helicopter is brought into another perfect hover. It is important to note that when the cyclic control is positioned to advance the helicopter in a certain direction, the gyroscope on the swash plate is used to maintain the swash plate in a stable position allowing a steady flight. The swash plate in this instance is not level but is stable. Any unstable movement of the helicopter is noted by the swash plate gyroscope that then adjusts the swash plate position to bring the flight. back to stability. When landing the helicopter the same principle applies, the collector is manipulated to allow the helicopter to drop lower but at the same time the swash plate, again using the stability that comes with a gyroscope mounted on the swash plate, maintains a steady hover over the landing site even as the helicopter drops to land. A complete auto-hover/auto-pilot/assisted-auto-landing device becomes quite feasible using the above schemes. The smart swash plate itself preferably runs on batteries that are embedded in the plate itself. The circuitry inside the plate can be made low power enough for the batteries to last for months if not years. In an alternative approach, it is possible to provide electrical power to the smart swash plate through rotating contacts on the main shaft of the helicopter. However such a mechanism would be costly, require extra maintenance, and would result in many modifications in the shaft design of the existing helicopters. The battery operated smart swash plate is stand-alone and requires only a simple battery check step in the maintenance procedures routinely performed on all existing helicopters.

In one embodiment, a quartz rate sensor type of gyroscope usually integrated on a silicon chip, is used. It has two mass-balanced quartz tuning forks, arranged “handle-to-handle” so forces cancel. Aluminum electrodes evaporated onto the forks and the underlying chip both drive and sense the motion. The system is both manufacturable and inexpensive. Since quartz is dimensionally stable, the system can be accurate.

As the forks are twisted about the axis of the handle, the vibration of the tines tends to continue in the same plane of motion. This motion has to be resisted by electrostatic forces from the electrodes under the tines. By measuring the difference in capacitance between the two tines of a fork, the system can determine the rate of angular motion.

These products include ‘tuning fork gyros’. Gyro is designed as an electronically-driven tuning fork, often fabricated out of a single piece of quartz or silicon. Such gyros operate in accordance with the dynamic theory that when an angle rate is applied to a translating body, a Coriolis force is generated.

Any gyroscope type of device used will optimally have a very fast response time between detecting motion and sending a signal.

In this description we use the term gyroscope as the device sending position signals to the helicopter controls; however this does not preclude other devices from sensing the position and sending control signals to the helicopter autopilot. Those skilled in the art will appreciate other types of location and motion sensing devices to substitute for the gyroscope.

Although the description above contains much specificity, these should not be construed as limiting the scope of the embodiments but as merely providing illustrations of some of several embodiments. Changes in the details may be made within the spirit and the scope of the invention, said spirit and scope to be construed broadly and not to be limited except by the character of the claims appended hereto.

What is claimed is:

1. A system in a helicopter having a rotor assembly and a swash plate, comprising:
a) a position sensing device mounted on said helicopter's swash plate;
b) the position sensing device transmitting a signal to a controller; and
c) the controller adjusting an angle of the swash plate enabling the swash plate to comply to a predetermined swash plate angle.

2. The system of claim 1 wherein the predetermined swash plate angle is such that a hover is maintained.

3. The system of claim 1 wherein the predetermined swash plate angle is such that the helicopter maintains a steady flight.

4. A means for maintaining a steady flight of a helicopter comprising:
a) a position sensing means located on a swash plate of the helicopter;
b) a transmitting means sending a position signal to a controller means; and
c) the controller means adjusting the swash plate if said adjustment is required for steady flight.

5. A means for maintaining a hover of a helicopter comprising:
a) a position sensing means located on a swash plate of the helicopter;
b) a transmitting means sending a position signal to a controller means; and
c) the controller means adjusting the swash plate if said adjustment is required for the hover.
